(19) United States
(12) Patent Application Publication
(10) Pub. No.: US 2005/0074041 A1
(43) Pub. Date: Apr. 7, 2005

(54) Diamond cooled laser gain assembly using low temperature contacting

(76) Inventors: Georg P. Sommerer, Berlin (DE); Alan B. Petersen, Palo Alto, CA (US); David E. Spence, Mountain View, CA (US); James D. Kafka, Palo Alto, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/917,830

(22) Filed: Aug. 12, 2004

Related U.S. Application Data
(63) Continuation-in-part of application No. 10/678,596, filed on Oct. 3, 2003.

(51) Int. Cl. H01S 3/04

(52) U.S. Cl. 372/34; 372/36

(57) ABSTRACT

An optical system includes a laser oscillator or a laser amplifier. The optical system includes a gain medium that is optically coupled to a pump source. A solid cooling element is in physical contact with a cooling surface of the gain medium. The gain medium and cooling element are held together using a low temperature contacting method. In a one embodiment the gain medium is a thin disk gain medium, the solid cooling-element is made from CVD-diamond, and the low temperature bonding technique is surface activated bonding.

### RELATED US APPLICATION DATA

This application is a Continuation-in-Part of U.S. application Ser. No. 10/678,596 filed Oct. 3, 2003 and fully incorporated herein by reference.

### BACKGROUND OF THE INVENTION

1. Field of the Invention

This invention relates to a laser gain medium and more particularly to a laser gain assembly using a transparent heat conducting element to achieve improved cooling, reduced thermally induced lensing, and improved thermo-mechanical robustness.

2. Description of Related Art

The output power available from diode-pumped, solid-state lasers is ultimately limited by the thermal and mechanical properties of the gain medium. However, often the method used to mount and cool the gain medium places further restrictions on the performance of the system. Even before the material fails mechanically, thermo-optical effects can lead to a degradation of the output beam quality and a loss in output power, which results from the formation of a thermally induced lens in the gain medium. This lens is a combination of the effects caused by the temperature dependence of the refractive index, often referred to as a “bulk thermal lens,” and from the deformation of the surface due to the thermal expansion of the material, often referred to as a “bulge.”

One way to mitigate the effects of the bulk thermal lens is to use a so-called one-dimensional (1-D) cooling geometry. In this configuration, the heat is extracted from the gain medium in such a way that the thermal gradients are longitudinal with respect to the laser beam. This was first taught by Almasi and Martin in U.S. Pat. No. 3,631,362, and has been used with some success by others since then. For example, Matthews and Marshall in OSA TOPS Vol. 50, page 138, 2001 applied the technique to Nd:YVO₄ laser rods to achieve reduced thermal lensing.

Matthews et al., in U.S. Pat. No. 5,363,391 taught that longitudinal cooling could also be used to improve to the performance of nonlinear crystal used in laser systems. This patent additionally teaches that it is advantageous to have a narrow gas-filled gap between the material to be cooled and the heat conducting media to prevent damage to the optical surfaces of the cooled material.

The disadvantage of these schemes is that the temperature in the laser medium is often higher than if it were cooled transversely. High temperatures can lead to many undesirable effects such as stress buildup and even fracture of the gain material, or of the bonds to other materials; in addition to a reduction in efficiency of the laser due to other effects, such as a decrease of the upper-state lifetime of the laser transition.

In U.S. Pat. No. 3,525,053, Chernoch taught that by using a gain medium with a high aspect ratio, i.e. with a diameter much greater than its thickness, it was possible to achieve 1-D cooling and a colder operating temperature. In a preferred embodiment, as taught by Abate, et al., Applied Optics, Vol. 20, page 351, 1981, a thin slab of gain material was directly cooled on the back with a flowing liquid. The back surface had a thin-film dielectric coating that was highly reflective at the laser wavelength and highly transmissive at the pump wavelength. The high aspect ratio meant that the heat generated in any part of the disk was efficiently transferred to the coolant, both because of the large surface area, and because of the close proximity of all parts of the disk volume to the coolant. This embodiment was often referred to as an “active mirror.”

A disadvantage of this embodiment is the complexity of the thin-film coating that has to be applied to the disk. There are two problems: first, the coating needs to be highly reflective at one wavelength and highly transmissive at the other. Secondly, the coating on the back of the disk is in direct contact with the liquid coolant, which imposes additional restrictions on its design and durability.

The following references teach that a solid cooling element can be used to avoid having liquid coolant in contact with the thin-film coating: Brown, et al., Applied Optics, Vol. 36, page 8611, 1997; Brauch, et al. in U.S. Pat. No. 5,553,088; and Liao, et al., Optics Letters, Vol. 24, page 1343, 1999. In these embodiments, the laser gain medium was bonded to a solid cooling element, which was then attached to a cooling apparatus such as a heat sink, that removed heat from the system. The bond between the gain medium and the cooling element was, alternately made up from one, or a number of, thin dielectric or metallic layers, or adhesives. If a soft metal is used, materials may not require good surface quality, but this limits the configuration to reflective geometries can still be used. Adhesives often cannot withstand high powers without damage, and soft metals or narrow gas-filled gaps do not always conduct the heat away as efficiently and uniformly as may be desired.

Alternative methods of bonding may involve direct bonding techniques including optical contacting or diffusion bonding as was taught by Meissner in U.S. Pat. No. 5,846,638. This patent includes a comprehensive summary and review of a large variety of bonding embodiments practiced by those skilled in the art. One commonly used example of a bonding technique is optical contacting. This is taught as a process by which two surfaces are adhered together through molecular attraction without the use of an adhesive. On the other hand, the technique of diffusion bonding a process similar to welding, by which two surfaces are bonded together though diffusion of the surfaces into one another. The method of bonding taught by Meissner requires the use of both optical contacting and elevated temperatures (>250° C.) for most laser crystals. Methods of bonding can also include other layers of additional materials, such as adhesives or solders that are added specifically to hold the two materials together. Soldering requires the structure to be heated above the melting point of the said additional material, followed by cooling so that the said additional material forms a solid bond. One example of a material that can be used as a solder is indium. Often, soldering requires the use of several different layers of materials to achieve a robust and durable bond. Indium can also be used as a bonding material when pressure is applied because it liquefies under pressure; this is referred to as pressure bonding.

There are, however, several disadvantages with all these bonding embodiments. The interface layers are desired to have good thermal conductivity. They also need to have good adhesion to one another, and to the disk and the solid cooling element. In addition, the inevitable differences in thermal expansion of the materials used in the disk, the interface layers, and the solid cooling element can cause stresses to built up in the structure and even cause the bond to fail altogether, or the material to fracture. There is also an increase in the detrimental lensing effects due to the more severe bulging of the material. Although the original active mirror designs, as taught by Abate, et al., allowed for stress-free radial expansion, the bonding embodiments as described above remove this advantage. This is particularly problematic for materials such as Nd:YVO₄ that have an anisotropic thermal expansion, and which are not suited to the method taught by Sutter and Kafka in co-pending U.S. patent application “Expansion Matched Thin Disk Laser and Method for Cooling,” Ser. No. 10/232,885, incorporated herein by reference. Yet a further disadvantage of said bonding embodiments is that the surface where most of the heating occurred was farthest away from the cooling element.

Bonding methods that involve the use of elevated temperatures have the disadvantage that the high temperatures may cause excessive mechanical stress to build up in the region of the bond that can ultimately result in the bond failing. This can be especially problematic if the two materials to be bonded have different coefficients of thermal expansion. Even if the bond does not fail, other adverse effects can occur. These adverse effects can include, but are not limited to, a change in the optical and or mechanical properties of the materials, a change in the structure of the materials, the formation of defects in the material, and the diffusion of intentional dopants out of the material and the diffusion of unintentional dopants into the material

One method of joining two possibly dissimilar materials that overcomes the disadvantages of the bonding methods mentioned above has been called surface activated bonding (SAB) and has been taught in, for example, Takagi, et al., Applied Physics Letters, Vol. 74, page 2387, 1999. In this technique, contaminants are removed from the surfaces and the surfaces are activated using a process such as Ar-beam etching. After activation, strong bonds are formed when the surfaces are brought together, even at room temperature and without any other processing. Bonding as strong as that in the bulk material has been demonstrated with this technique.

A variation of this method has been taught, for example, by Tong, in U.S. Pat. No. 6,563,133. In this technique, the surfaces are activated using a B₂H₆ plasma etch and dipped in an HF solution immediately before bonding. The bond was again formed at room temperature, but there was an additional post-processing step, where the samples were annealed under low vacuum at a temperature higher than room temperature, but lower than the temperature where unwanted changes in the materials or the interfaces occurred. Typically, the temperature was kept below 250° C.-300° C.

It is also possible to activate the surfaces by using various chemical-mechanical polishing techniques, or wet and dry, or dry-only chemical activation processes. It will be obvious to those skilled in the art that other surface activation processes can also be used.

Because these methods can be carried out at relatively low temperatures and do not involve the use of any additional bonding materials, the joint can be very strong, have little detrimental effect on the thermal conductivity, have low optical loss, and introduce negligible additional stresses into the materials. The methods of Takagi and Tong have, however, only been applied to semiconductor or electro-ceramic materials and have not been demonstrated as effective with other types of materials such as solid-state laser crystals, especially in the presence optical coatings.

There is, therefore, a need for efficiently cooled high power solid-state lasers that have a weak thermally induced lens, a small temperature rise in the laser gain medium, possess simplified dielectric coatings with good thermal conductivity and. reduced thermally induced stress, all of which are achieved using contacting techniques that do not require heating joined materials to high temperature.

### SUMMARY OF THE INVENTION

Accordingly, an object of the present invention is to provide efficient cooling of the laser gain material using low temperature contacting techniques between the gain material and the cooling element. In one embodiment, the contacting process is a surface activated bonding.

Another object of the present invention is to provide one embodiment of a low temperature contacting process that can be carried out without any temperature cycling.

Yet another object of the present invention is to adapt the low temperature contacting techniques to gain medium assemblies incorporated in high power solid-state lasers, and their methods of use, so as to produce small temperature rise in the laser gain material, resulting in a weak thermally induced lens. In some embodiments of the present invention, the low temperature contacting techniques also provide for reduced thermally induced stress, which is a desirable aspect in high power solid state lasers operating with good beam quality.

A further object of the present invention is to provide efficient cooling of the laser gain material incorporated in high power solid-state lasers, and their methods of use, that allow use of simplified dielectric coatings with good thermal conductivity.

Another object of the present invention is to provide bonds joining two dissimilar materials that do not cause excessive mechanical stress to build up in the region of the bond that can ultimately result in the bond failing.

Yet another object is to provide such bonds with materials such as solid-state laser crystals, especially in the presence optical coatings.

These and other objects of the present invention may be achieved in, an optical system with a pump source. In one embodiment of such a system, a gain medium is optically coupled to the pump source. A solid cooling element is provided in physical contact with a cooling surface of the gain medium. The cooling element and gain medium may be held together by using a low temperature contacting technique without an intermediate bonding layer, such as, but not limited to, an adhesive, a gas, or a metallic layer. The surfaces of gain medium and cooling element can include one or more thin-film coatings that are used to provide the desired optical properties at the interfaces. In some embodiments, the thin-film coating may be a multi-layer dielectric coating. A mounting apparatus may be used to hold the solid cooling element and the gain medium. In some embodiments, the mounting apparatus may be configured or joined to apply opposing forces to solid cooling elements in a direction substantially normal to the cooling surfaces. A surface activated bond may be formed using the low temperature contacting technique.

In another embodiment of the present invention, a method is provided for removing heat from a gain medium of an optical system. A solid cooling element is held in physical contact with a cooling surface of the gain medium. The surfaces of gain medium and cooling element can again include one or more thin-film coatings that are used to provide the desired optical properties at the interfaces. The adjoining surfaces of the cooling element and gain medium may be held together at their interface by a low temperature contacting technique. During operation of the laser system, the gain medium is then efficiently cooled through the contacted interface.

A further understanding of the nature and advantages of the invention will become apparent by reference to the remaining portions of the specification and drawings.

### BRIEF DESCRIPTION OF THE DRAWINGS

FIG. 1 is a schematic diagram illustrating one embodiment of the present invention with a gain medium, solid cooling elements and a mounting apparatus.

FIG. 2(a) is a schematic diagram illustrating one embodiment of the present invention with an optical system comprising: a pump source, a coupling apparatus, and a gain assembly, where the optical system is configured as a laser oscillator.

FIG. 2(b) is a schematic diagram illustrating one embodiment of the present invention with an optical system comprising: a pump source, a coupling apparatus, and a gain assembly, where the optical system is configured as an amplifier.

FIG. 3(a) is a schematic diagram illustrating the location of thin-film coatings that can be utilized with the embodiment of FIG. 1 when used in a double-pass configuration with material having indices of refraction that are similar.

FIG. 3(b) is a schematic diagram illustrating the location of thin-film coatings that can be utilized with the embodiment of FIG. 1 when used in a double-pass configuration with material having indices of refraction that are not similar.

FIG. 3(c) is a schematic diagram illustrating the location of thin-film coatings that can be utilized with the embodiment of FIG. 1 when used in a single-pass configuration with material having indices of refraction that are similar.

FIG. 3(d) is a schematic diagram illustrating the location of thin-film coatings that can be utilized with the embodiment of FIG. 1 when used in a single-pass configuration with material having indices of refraction that are not similar.

FIG. 4 illustrates the calculated temperature distribution within a gain assembly for: (a) a single copper cooling element; and (b) two diamond cooling elements.

### DETAILED DESCRIPTION OF THE PREFERRED EMBODIMENT

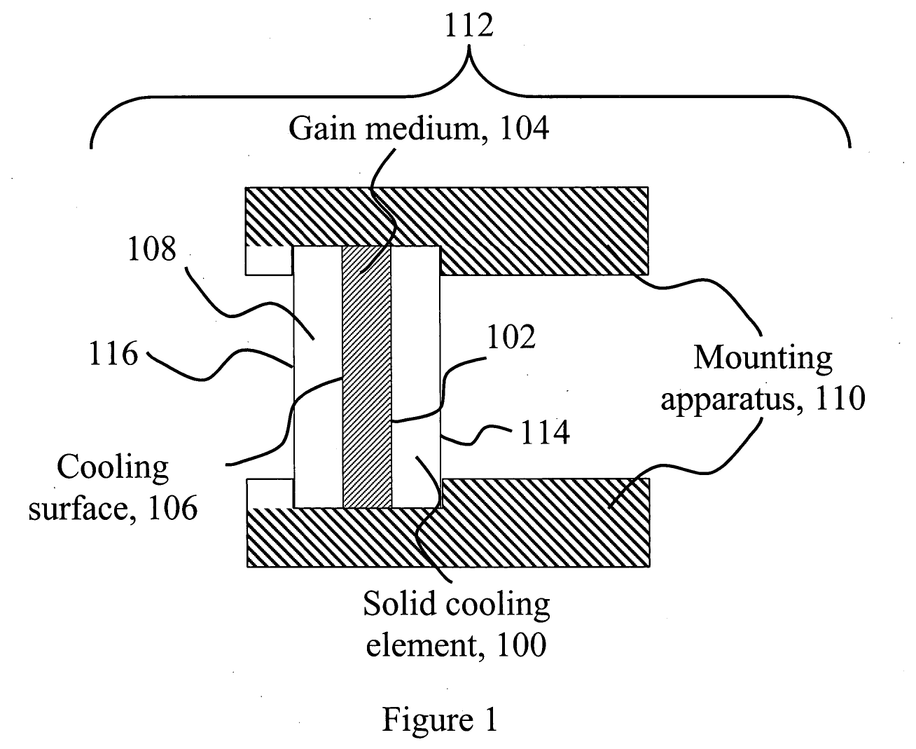

As illustrated in FIG. 1, in one embodiment of the present invention, a gain assembly 112 comprises: at least a first solid cooling element 100 that is in physical contact with a cooling surface 102 of gain medium 104. Two cooling surfaces 102 and 106, and two solid cooling elements 100 and 108 are provided. Heat flow through the gain medium 104 can be substantially one-dimensional, in a direction substantially normal to the cooling surfaces 102 and 106. Solid cooling elements 100 and 108 are held in contact with gain medium 104 at surfaces 102 and 106 by a low temperature contacting technique. The surfaces of gain medium 104 and cooling elements 100 and 108, can include one or more thin-film coatings that are used to provide the desired optical properties at the interfaces. In another embodiment of the present invention, the low temperature contacting technique is Surface Activated Bonding (SAB). In yet another embodiment of the present invention, the low temperature contacting technique uses the mounting apparatus 110, to apply opposing forces to solid cooling elements 100 and 108 in a direction substantially normal to the cooling surfaces 102 and 106. Thus, the mounting apparatus 110 holds solid cooling elements 100 and 108 to gain medium 104. In various embodiments, one or both of solid cooling elements 100 and 108 can be, sapphire, CVD diamond, single-crystal CVD diamond, a material having a thermal conductivity >100 Wm⁻¹K⁻¹, and the like. At least one of the solid cooling elements 100 and 108 can have a high transmission at the laser wavelength. At least one of the solid cooling elements 100 and 108 can have a high transmission at the pump wavelength.

Again referring to FIG. 1, in an embodiment of the present invention, solid cooling elements 100 and 108 are joined to gain medium 104 at surfaces 102 and 106, using a low temperature contacting technique such as Surface Activated Bonding. The surfaces of gain medium 104 and cooling elements 100 and 108 can again include one or more thin-film coatings that are used to provide the desired optical properties at the interfaces. A mounting apparatus 110 holds solid cooling elements 100 and 108, and gain medium 104. In another embodiment of the present invention, the low temperature contacting technique involves using the mounting apparatus 110 to apply opposing forces to solid cooling elements 100 and 108 in a direction substantially normal to the cooling surfaces 102 and 106. Thus, the mounting apparatus 110 holds solid cooling elements 100 and 108 to gain medium 104. The gain medium 104 is in thermal contact with the solid cooling elements 100 and 108, so that heat can be removed from the gain medium 104. The mounting apparatus 110 can provides additional structural stability to gain medium 104 and the solid cooling elements 100 and 108. In various embodiments, gain medium 104 is placed between solid cooling elements 100 and 108, so that the cooling surfaces 102 and 106, of the gain material 104 are in physical contact with the solid cooling elements 100 and 108. In order to provide good thermal and physical contact, the surfaces of gain medium 104 and the surfaces of solid cooling elements 100 and 108 that are in contact with the gain medium need to have a sufficiently small surface roughness. Typically surface roughness will be less than 50 nm Ra and preferably less than 5 nm Ra.

Gain medium 104 can be a thin disk gain medium with one-dimensional heat flow. A thin disk gain medium typically has one dimension, the thickness, much smaller than the other two cross-sectional dimensions. For example, a thin disk might have a diameter of a few millimeters and a thickness of only a fraction of a millimeter. If the disk is thin enough, the heat-flow will be substantially 1-dimensional. Gain medium 104 can be made of a variety of materials including but not limited to, Nd:YVO4, Yb:YAG, Yb:KGW, Yb:KYW, apatite-structure crystals, a stoichiometric gain material, a stoichiometric Yb3+ gain material, a semiconductor, and the like. The stoichiometric Yb3+ gain material can be KYbW or YbAG.

Referring again to FIG. 1, a cooling medium is provided to cool solid cooling elements 100 and 108. The cooling medium can cool solid cooling elements 100 and 108 by a variety of methods that include, but are not limited to: direct liquid cooling, convective cooling, both convective and conductive cooling, and the like. Examples of cooling media include, but are not limited to: air, water, ethylene glycol, copper, and the like. In one embodiment, the solid cooling element 100 is cooled using water as the cooling medium. In this embodiment, the water is in direct contact with surface 114 of solid cooling element 100. Solid cooling element 108 is also cooled with a cooling medium that is in contact with surface 116 of solid cooling element 108. In one embodiment, the cooling medium is air.

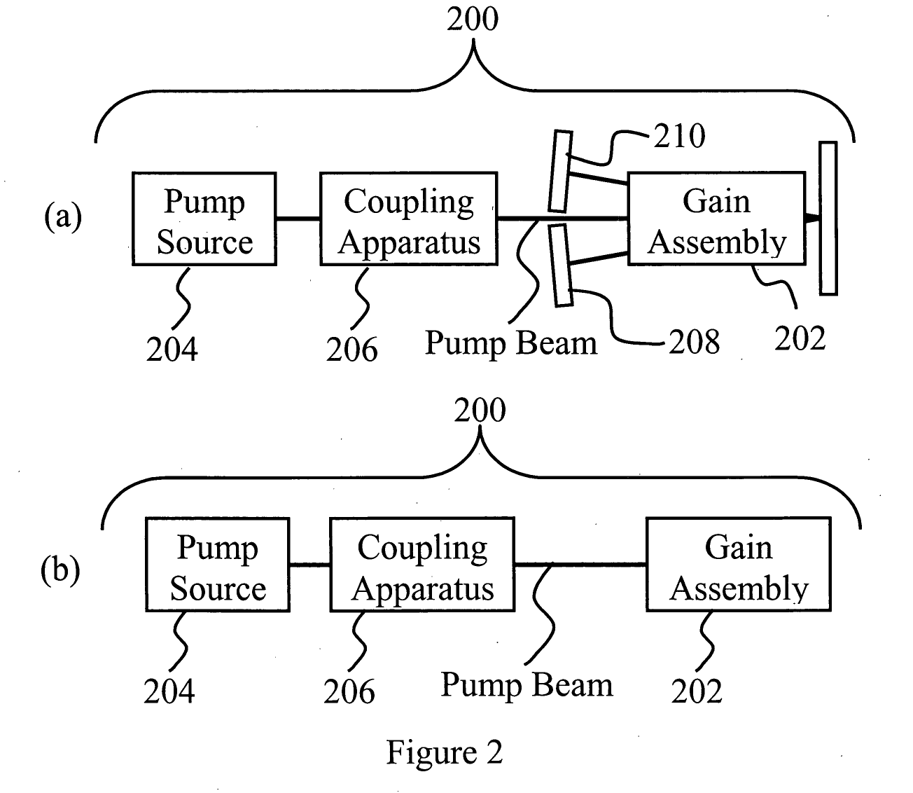

As shown in FIGS. 2(a) and 2(b), one embodiment of the present invention is an optical system 200 comprising the gain assembly 202, which is substantially the same as gain assembly 112 of FIG. 1, together with a pump source 204. The gain assembly 202 is optically coupled to the pump source 204 by a coupling apparatus 206. FIG. 2(a) illustrates an embodiment where optical system 200 is configured as a laser. High reflector 208 and output coupler 210 are provided to form a resonator. Other optical elements may also be provided in the resonator. The laser can be Q-switched, mode-locked, and the like. As shown in FIG. 2(b), optical system 200 is configured as an amplifier.

A variety of different pump sources 204 can be utilized including but not limited to fiber coupled diode bars, and diode stacks. A variety of coupling apparatus 206 can be utilized, including but not limited to lenses, non-imaging concentrators such as lens ducts or hollow funnels and the like. Thin film coatings can be applied to various surfaces of the gain assembly 112. In general, suitable thin-film coatings can include, but are not limited to, multi-layer dielectric coatings, AR-coatings, HR-coatings, dichroic coatings, dielectric coatings, metallic coatings, combination of at least one of a set of coatings selected from: AR-coatings, HR-coatings, dichroic coatings, dielectric coatings, metallic coatings, and the like. AR coatings can reduce the optical loss when adjacent materials have substantially different refractive indices. HR coatings can be used to provide a double pass through the gain assembly.

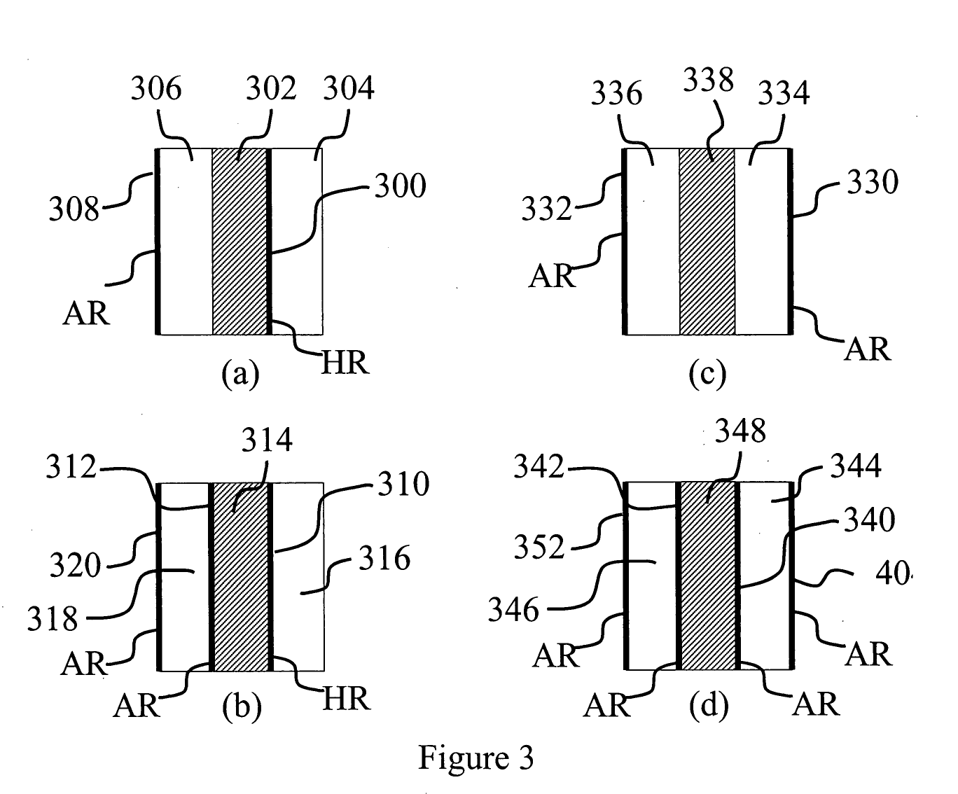

As shown in the embodiment of FIG. 3(a), a thin-film coating 300 can be provided between gain medium 302 and solid cooling element 304. In this embodiment the thin film coating 300 can be highly reflecting at the laser wavelength and possibly at the pump wavelength. A thin-film coating 308 can also be provided on the surface of solid cooling element 306 that is not in contact with gain medium 302. Thin-film coating 308 can be an anti-reflection coating for the laser wavelength and possibly also for the pump wavelength. In this embodiment, the gain assembly can be used in a double-pass configuration. The indices of refraction of gain medium 302 and solid cooling element 306 are close enough in value that a thin-film coating is not required between them.

FIG. 3(b) also shows an embodiment where the gain assembly 314 is used in a double-pass configuration, but here a thin-film coating 312 is provided between solid cooling element 318 and gain medium 314. A thin-film coating 310 can also be provided between solid cooling element 316 and gain medium 314. In addition, a thin-film coating 320 can be provided on the surface of solid cooling element 318 that is not in contact with gain medium 314. In this embodiment, thin-film coatings 312 and 320 can be anti-reflection coatings for the laser wavelength and possibly the pump wavelength, and thin-film coating 310 can be highly reflecting at the laser wavelength and possibly the pump wavelength.

In the embodiment illustrated in FIG. 3(c), the gain assembly is used in a single-pass configuration. Thin-film coatings 330 and 332 can be provided on the surfaces of solid cooling elements 334 and 336 that are not in contact with gain medium 338. Thin-film coatings 330 and 332 can be anti-reflection coatings for the laser wavelength and possibly anti-reflecting or highly-reflecting for the pump wavelength. The indices of refraction of gain medium 338 and solid cooling elements 334 and 336 are close enough in value that a thin-film coating is not required between them.

As shown in the embodiment of FIG. 3(d), thin-film coatings 340 and 342 can be provided between solid cooling elements 344 and 346 and the gain medium 348. Thin-film coatings 350 and 352 can also be provided on the surfaces of solid cooling elements 344 and 346 that are not in contact with gain medium 348. In this embodiment thin-film coatings 340, 342, 350, and 352 can be anti-reflection thin-film coatings for the laser wavelength, and anti-reflection or high-reflection thin-film coatings for the pump wavelength. In this embodiment, the gain assembly is used in a single pass configuration.

Referring again to FIGS. 1, 2(a) and 2(b), obviously, it is desirable to remove heat from gain medium 104 of the optical system 200 as efficiently as possible. The thermal conductivity of any material that comes between gain medium 104 and the cooling medium should, therefore, have as high a thermal conductivity as possible. Also, the cooling medium should be positioned as close to the location where the heat is deposited as possible.

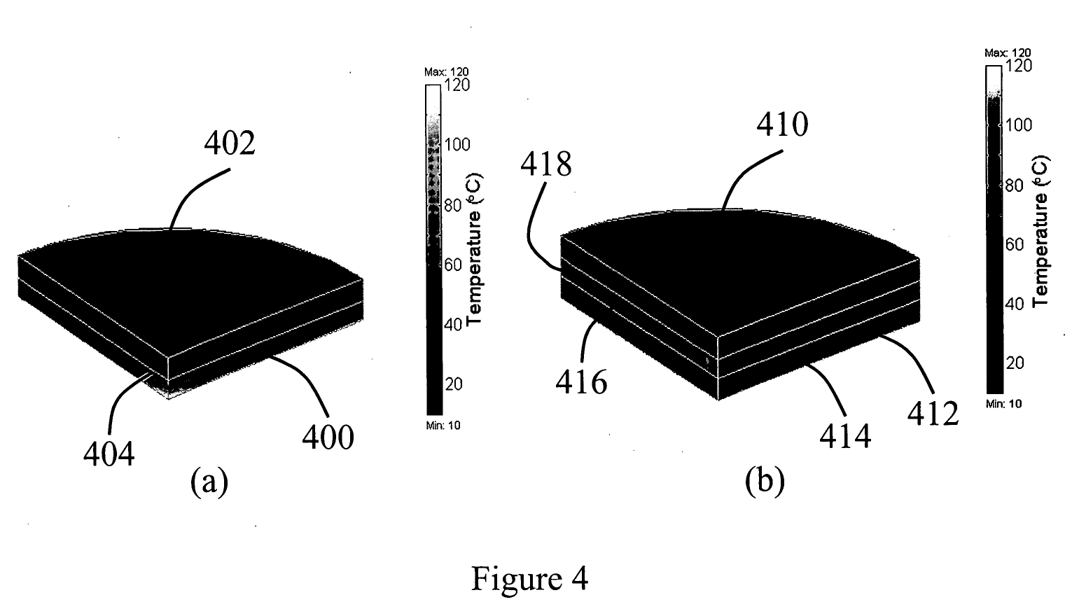

FIGS. 4(a) and 4(b) illustrate these advantages. FIG. 4(a) shows the temperature distribution in a thin disk gain medium 400 attached to a copper cooling-element 402. In this figure, the pump light enters from the bottom and thus the cooling surface 404 of gain medium 400 is the surface that is furthest away from the region where most of the heat is deposited. Copper, has a thermal conductivity of less than 400 Wm⁻¹K⁻¹. The maximum temperature rise in gain medium 400 is calculated to be about 100° C. In FIG. 4(b) cooling element 410 is made from a material having a thermal conductivity of greater than 1800 Wm⁻¹K⁻¹, such as CVD-diamond, and the like. In addition there are cooling elements 410 and 412 in contact with both surfaces 414 and 416 of the thin disk gain medium 418, so that heat can be efficiently removed more directly from the region where it is deposited. FIG. 4(b) shows that the maximum temperature rise is much less; in fact it is only about 50° C. for the case illustrated.

Referring again to FIG. 1, when choosing materials for use as solid cooling elements 100 and 108, it may not be possible to find materials that have a high thermal conductivity and simultaneously have thermal expansion coefficients that are close in value to those of gain medium 104. By using a low temperature contacting technique such as Surface Activated Bonding, it is less likely that the gain material will fracture or bulge as a result of changes in temperature.

In addition, there will be a much smaller thermal resistance across the interfaces 102 and 106 between solid cooling elements 100 and 108 and gain medium 104. As a result, heat will be more efficiently extracted from gain medium 104, which should allow much higher pump power levels to be used than has previously been possible.

Referring again to FIGS. 1, 2(a) and 2(b), in one embodiment of the present invention, a method of removing heat from gain medium 104 of optical system 200 holds solid cooling elements 100 and 108 in physical contact with cooling surfaces 102 and 106 of gain medium 104. Gain medium 104 is then cooled, so that there is a reduced bulge. Gain medium 104 is also cooled so that the temperature in gain medium 104 is lower than if it were cooled by a different method. Gain medium 104 is also cooled so that there is a reduced thermal lens in gain media 104. Gain medium 104 is also cooled without causing a fracture of the gain material, and the like.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. An optical system, comprising:
a pump source;
a gain medium optically coupled to the pump source;
a solid cooling element in physical contact with a cooling surface of the gain medium, and joined using a low temperature contacting technique; and
a mounting apparatus that holds the solid cooling element and the gain medium.

2. The system of claim 1 wherein the low temperature contacting technique is surface activated bonding.

3. The system of claim 1 wherein the temperature is kept below 250° C.

4. The system of claim 1 wherein the low temperature contacting technique involves the mounting apparatus applying forces to the solid cooling elements in a direction substantially normal to the cooling surfaces.

5. The system of claim 1, wherein the optical system is a laser.

6. The system of claim 5, wherein the laser is Q-switched.

7. The system of claim 5, wherein the laser is mode-locked.

8. The system of claim 1, wherein the optical system is an amplifier.

9. The system of claim 1, wherein there are two cooling surfaces and two solid cooling elements.

10. The system of claim 1, wherein the heat flow is substantially 1-dimensional.

11. The system of claim 1, wherein the gain medium is a thin disk gain medium.

12. The system of claim 11, wherein the thin disk gain medium has a ratio of cross-section to thickness that is greater than 10.

13. The system of claim 9, wherein the solid cooling elements are held in contact with the gain medium by an interface formed by a low temperature contacting technique.

14. The system of claim 13 wherein the low temperature contacting technique is surface activated bonding.

15. The system of claim 14 wherein the temperature is kept below 250° C.

16. The system of claim 13 wherein the low temperature contacting technique involves the mounting apparatus applying forces to the solid cooling elements in a direction substantially normal to the cooling surfaces.

17. The system of claim 1 wherein one or both of the solid cooling-elements are transparent at least one of the laser wavelength and the pump wavelength.

18. The system of claim 1, wherein one or both of the solid cooling elements are sapphire.

19. The system of claim 1, wherein one or both of the solid cooling elements have a thermal conductivity >100 Wm⁻¹K⁻¹.

20. The system of claim 1, wherein one or both of the solid cooling elements are CVD diamond.

21. The system of claim 1, wherein one or both of the solid cooling elements are single-crystal, CVD diamond.

22. The system of claim 1, wherein the gain medium is Nd:YVO₄.

23. The system of claim 1, wherein the gain medium is a Yb-doped crystal.

24. The system of claim 23, wherein the Yb-doped crystal is Yb:YAG.

25. The system of claim 23, wherein the Yb-doped crystal is Yb:KGW.

26. The system of claim 23, wherein the Yb-doped crystal is Yb:KYW.

27. The system of claim 1, wherein the gain medium is an apatite-structure crystal.

28. The system of claim 1, wherein the gain medium is a stoichiometric gain material.

29. The system of claim 28, wherein the gain medium is a stoichiometric Yb³⁺ gain material.

30. The system of claim 29, wherein the stoichiometric Yb³⁺ gain material is KYbW.

31. The system of claim 29, wherein the stoichiometric Yb³⁺ gain material is YbAG.

32. The system of claim 1, wherein the gain medium is a semiconductor.

33. The system of claim 1, wherein the pump source is a fiber coupled diode bar.

34. The system of claim 1, wherein the pump source is a diode stack.

35. The system of claim 1, wherein one of the solid cooling elements is directly liquid-cooled.

36. The system of claim 1, wherein one of the solid cooling elements is convectively cooled.

37. The system of claim 1, wherein one of the solid cooling elements is both convectively and conductively cooled.

38. The system of claim 1, wherein there is a thin-film coating between the gain medium and the solid cooling element.

39. The system of claim 38, wherein the thin-film coating is a multi-layer dielectric coating.

40. The system of claim 38, wherein the thin-film coating is an AR-coating.

41. The system of claim 38, wherein the thin-film coating is a HR-coating.

42. The system of claim 38, wherein the thin-film coating is a dichroic coating.

43. The system of claim 38, wherein the thin-film coating is a dielectric coating.

44. The system of claim 38, wherein the thin-film coating is a metallic coating.

45. The system of claim 38, wherein the thin-film coating is a combination of at least one of a set of coatings selected from: AR-coatings, HR-coatings, dichroic coatings, dielectric coatings, and metallic coatings.

46. A method of removing heat from a gain medium of an optical system, comprising:
providing a solid cooling element in physical contact with a cooling surface of the gain medium;
contacting the gain medium and solid cooling element using a low temperature technique; and
cooling the gain medium through the interface between said solid cooling element and said surface of the gain medium.

47. The method of claim 46, wherein the low temperature technique is surface activated bonding.

48. The method of claim 46 wherein the temperature is kept below 250° C.

49. The method of claim 46, wherein the low temperature technique involves the mounting apparatus applying forces to the solid cooling elements in a direction substantially normal to the cooling surfaces.

50. The method of claim 46, wherein the low temperature contacting technique involves no intermediate bonding layers.

51. The method of claim 46, wherein the low temperature contacting technique involves no intermediate gas-filled gaps.

52. The method of claim 46, wherein the gain medium has two cooling surfaces, each contacted to a solid cooling element.

53. The method of 46, wherein cooling of the gain medium is performed in a way to reduce a thermally-induced bulge.

54. The method of claim 46, wherein cooling of the gain medium is performed in a way to reduce the maximum temperature.

55. The method of claim 46, wherein cooling of the gain medium is performed in a way without creating a fracture of the gain material.

56. The method of claim 46, wherein cooling of the gain medium is performed in a way to reduce a thermally induced lens.
